(19) United States
(12) Patent Application Publication
(10) Pub. No.: US 2025/0307913 A1
(43) Pub. Date: Oct. 2, 2025

(54) LIMIT EXCESS DETERMINATION AND REMEDIATION

(71) Applicant: Capital One Services, LLC, McLean, VA (US)

(72) Inventors: Keegan FRANKLIN, Tuscon, AZ (US); James BRIGHTER, Reston, VA (US); Megan OBRIEN, New Orleans, LA (US); John MAILLETT, Arlington, VA (US); Jane JUSTIZ, McLean, VA (US); Vishnu SETH, New York, NY (US)

(73) Assignee: Capital One Services, LLC, McLean, VA (US)

(21) Appl. No.: 18/623,452

(22) Filed: Apr. 1, 2024

(51) Int. Cl. G06Q 40/02; G06V 30/19; G06V 30/30

(52) U.S. Cl. CPC G06Q 40/02; G06V 30/19; G06V 30/30

(57) ABSTRACT

A computer implemented method, system, and non-transitory computer-readable device for a digital document verification process. In some embodiments, a split deposit tool may be provided in a mobile banking application to allow a customer to split a deposit and schedule deposit dates for various portions of the split deposit. In some embodiments, the split deposit tool may be provided in response to a determination that an amount of a check in an image exceeds a remaining remote deposit limit. In some embodiments, the amount may be determined using real-time optical character recognition (OCR), for example, active OCR performed on a live stream of check imagery.

### BACKGROUND

As technology evolves, institutions have found ways to make digital document verification more convenient for customers. For example, in the financial industry, mobile banking apps may let a customer remotely deposit paper checks from virtually anywhere using their smartphone or tablet. However, it is difficult to quickly determine whether a document submitted for digital verification with a request for services, goods, or funds meets the requirements of the institution facilitating digital document verification. This is because such a determination often requires detailed image processing, which may require time and extensive computing resources, or alternatively the review of an individual. Furthermore, it can be difficult to provide, in real time, the opportunity for a user of a digital document verification system to remediate any issues with a document and/or request for services, goods, or funds, for example, when the document and/or request violates a limit policy put in place by the institution facilitating digital document verification. It may be advantageous to provide a user the opportunity to modify services, goods, or funds requested and/or the schedule of delivery of such services, goods, or funds in real time, before extensive image processing and/or additional verifications of a document image are conducted.

### BRIEF DESCRIPTION OF THE DRAWINGS

The accompanying drawings are incorporated herein and form a part of the specification.

FIG. 1 illustrates a remote deposit check capture, according to some embodiments.

FIG. 2 illustrates example remote deposit OCR segmentation, according to some embodiments.

FIG. 3 illustrates a block diagram of a remote deposit system architecture, according to some embodiments.

FIG. 4 illustrates a flow diagram of a remote deposit system, according to some embodiments.

FIG. 5 illustrates a block diagram of a client computing device, according to some embodiments.

FIGS. 6A-6C illustrate user interfaces for a remote deposit system, according to some embodiments.

FIGS. 7A-7B illustrate user interfaces for a remote deposit system, according to some embodiments.

FIG. 8 illustrates a block diagram of a split deposit system, according to some embodiments.

FIG. 9 illustrates a block diagram of a split deposit system, according to some embodiments.

FIG. 10 illustrates a flow diagram for a remote deposit method, according to some embodiments.

FIG. 11 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for implementing an interface for a user to modify and/or schedule services, goods, or funds requested in exchange for document verification, particularly if the requested services, goods, or funds initially violate a limit set by an institution. For example, the disclosed embodiments may implement deposit split and deposit scheduling on a mobile or desktop computing device to assist, in real-time, a customer electronically depositing a financial instrument such as a check.

The embodiments disclosed herein may be implemented in any context in which digital verification of a document is required to provide access to services, goods, funds, etc. In particular, the embodiments disclosed herein may be implemented whenever an institution must determine whether requested services, goods, funds, etc. exceed a limit imposed on or by the institution. In some cases, the requested services, goods, funds, etc., are specified in a document depicted in an electronic image provided for verification, such that image processing is required to identify the amount of services, goods, funds, etc. requested. In some embodiments, the embodiments disclosed herein may be implemented as part of a mobile check deposit process. Mobile check deposit is a fast, convenient way to deposit funds using a customer's mobile device or laptop. As financial technology and digital money management tools continue to evolve, the process has become easier than ever before. Mobile check deposit is a way to deposit a financial instrument, e.g., a paper check, through a banking app using a smartphone, tablet, laptop, etc. Currently, mobile deposit may allow a bank customer to capture a picture of a check using, for example, their smartphone or tablet camera and upload it through a mobile banking app running on the mobile device. Deposits commonly include personal, business or government checks

Currently, computer-based (e.g., laptop) or mobile-based (e.g., mobile device) technology may allow a customer to initiate a document uploading process for uploading images or other electronic versions of a document to a backend system (e.g., a document processing system) for various purposes. One of those purposes may be mobile check deposit. In some cases, this technology may prevent a customer from depositing funds due to the customer exceeding a remote deposit limit. The remote deposit limit may be set for a particular timeframe, and may be, for example, a maximum amount the customer may remotely deposit within a day, a week, a month, or a year. The remote deposit limit may be associated with the customer and/or a customer account. In some embodiments, the remote deposit limit may be determined on a customer-specific basis prior to the upload process and may be stored in a memory of a backend system and/or a client device. In some embodiments, the remote deposit limit may be a global limit that applies to all or a subset of customers of the mobile banking app.

Remote deposit limits may be necessary, in many cases, to mitigate the risk of fraud. In some cases, remote deposit systems may be more vulnerable to fraud due to limited or nonexistent human review of check images. Accordingly, banks may implement remote deposit limits to prevent the fraudulent deposit of funds, as repeated deposits and high check amounts may be associated with fraudulent behavior. But on the customer side, the existence of remote deposit limits may pose a problem, especially as the prevalence of remote banking increases. Those who rely on remote banking technologies may face considerable challenges in depositing valid checks. For example, a customer of a bank who does not live close to a physical location of the bank may be forced to travel long distances to deposit a check that has been rejected during the remote deposit process. Alternatively, the customer may be forced to wait until the end of a timeframe associated with a remote deposit limit before gaining access to any of the funds associated with a valid check. While waiting, the customer may be frustrated by having to take care of and store the valid check securely until remote deposit limits reset.

Most banks and financial institutions use additional advanced security features to keep an account safe from fraud during the mobile check deposit workflow. For example, security measures may include encryption and device recognition technology. In addition, remote check deposit apps typically capture check deposit information without storing the check images on the customer's mobile device (e.g., smartphone). Mobile check deposit may also seek to eliminate or reduce typical check fraud as a thief of the check may not be allowed to subsequently make use of an already electronically deposited check, whether it has cleared or not and may provide an alert to the banking institution of a second deposit attempt. In addition, fraud controls may include mobile security alerts, such as mobile security notifications or SMS text alerts, which can assist in uncovering or preventing potentially fraudulent activity. Remote deposit limits may exist alongside of these and other security measures.

The technology described herein in the various embodiments may implement a remote deposit split and scheduling process to provide a customer access to at least a portion of check funds even if the check exceeds a current remote deposit limit. The technology described herein may implement a pre-deposit assessment of whether a check amount exceeds a current remote deposit limit. The technology described herein may assess various splits of the check that do not exceed current limits and may offer to a customer the ability to select deposit splits and deposit schedules. In some embodiments, an active OCR may be performed at the mobile or desktop computing device to obtain data (e.g., a check amount) for determining available deposit splits and deposit schedules. OCR is the electronic or mechanical conversion of images of typed, handwritten or printed text into machine-encoded text, whether from a scanned document, a photo of a document, a scene photo, stream of image data, etc. Utilizing active OCR, data (e.g., check amount, signature, MICR line, account number, etc.) may be extracted from streamed imagery of the check, without requiring an image capture to be communicated to a remote deposit server or remote OCR processing to be performed. In some embodiments, active OCR need not be performed, and data entered manually by the customer (e.g., the check amount) may be used to determine available deposit splits and deposit schedules.

Active OCR is described in U.S. patent application Ser. No. 18/503,778, filed Nov. 7 2023 and titled “ACTIVE OCR,” the disclosure of which is incorporated by reference herein in its entirety. Any reference to active OCR in the present application should be understood to refer to any one of the embodiments of active OCR described therein (including implementing active OCR using a thin client with the assistance of a backend system). As short summary, active OCR may include performing OCR on a live image stream during a current customer transaction time period. For example, the active OCR process may be completed before finalization of a remote deposit operation. Active OCR of a financial instrument may employ image analysis features at a client device (e.g., a smartphone) to extract text from a live image stream of the financial instrument and forward extracted data without requiring capture of an image or image frame for later transmission to a backend system. Additionally, active OCR may be performed on multiple images or partial images that are ranked according to their quality, as described in U.S. patent application Ser. No. 18/503,787, filed Nov. 7, 2023 and titled “BURST IMAGE CAPTURE,” the disclosure of which is incorporated by reference herein in its entirety.

While active OCR is mentioned above, any real-time OCR procedure may be implemented, such as that described in U.S. application Ser. No. 18/092,617, filed Jan. 3, 2023 and titled “INSTANT OPTICAL CHARACTER RECOGNITION DURING UPLOAD PROCESS,” the disclosure of which is incorporated by reference herein in its entirety. In some embodiments, all or a part of any real-time OCR procedure implemented may be performed on a backend server. By implementing active OCR or any other real-time OCR procedure, the technology described herein in the various embodiments may obtain check data (e.g., an amount) required to determine available deposit splits and deposit schedules in real-time (e.g., within a current customer transaction period before a customer submits a deposit request or immediately after in response to the customer submitting a deposit request). Accordingly, the technology described herein may provide to a customer the ability to select available deposit splits and deposit schedules in real-time. The customer may be able to edit deposit splits and deposit schedules via a user interface of the customer's computing device.

In some embodiments, one or more models (in some cases, machine learning (ML) models) may be implemented in tandem with real-time OCR to determine available deposit splits and deposit schedules. For example, the one or more models may receive an amount of a check obtained from a check image using real-time OCR and may consider customer deposit history and limit policies to determine whether the amount exceeds a remaining remote deposit limit. The one or more models may additionally determine, based on the amount, customer deposit history, limit policies, risk factors associated with the image, etc., available deposit splits and deposit schedules (how much can be deposited at what times). Based on the results of the one or more models, a mobile banking app may display on the customer's computing device options for selecting deposit split amount(s) and deposit date(s). In some embodiments, the one or more models may include an ML funds availability model as described in U.S. application Ser. No. 18/509,748, filed Nov. 15, 2023 and titled “DEPOSIT AVAILABILITY SCHEDULE,” the disclosure of which is incorporated by reference herein in its entirety. Using one or more models to determine available deposit splits and deposit schedules may ensure the deposit splits and deposit schedules are “preapproved” even before they are provided to the customer as amount/scheduling options. Alternatively, or in addition, one or more models may be used to vet a deposit split and deposit schedule selected by a customer after selection by the customer.

While described in the context of banking, the concepts disclosed herein apply to any document image capture and/or transmission scenario in which the recipient does not receive a physical copy of the document but relies upon information contained therein to provide services, goods, funds, etc. to the party sending the document image (e.g., an image of a purchase order to obtain a certain number of units of a product, where the requested number of units may exceed a limit for a timeframe or exceed existing inventory).

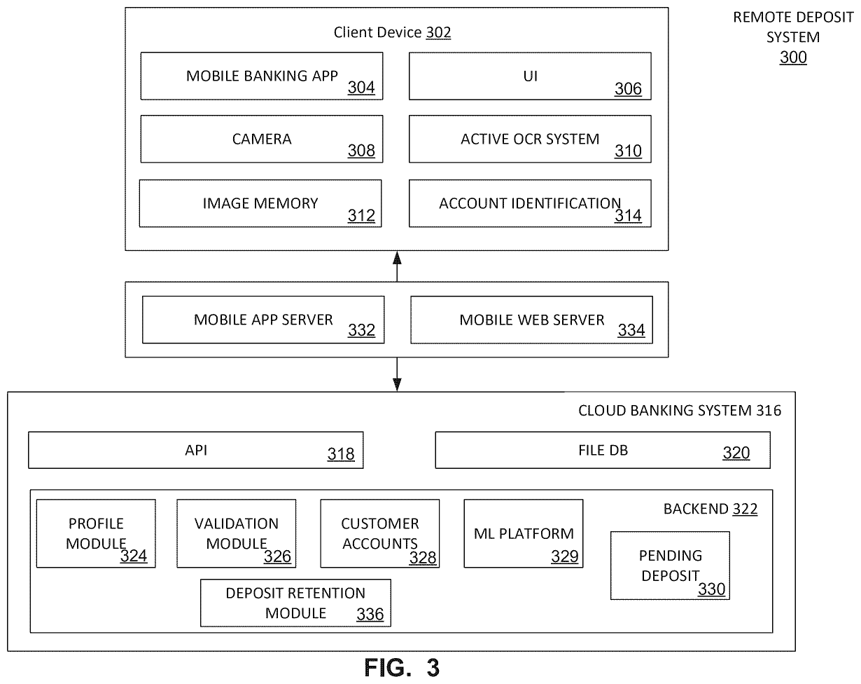

Various embodiments of this disclosure may be implemented using and/or may be part of a remote deposit systems shown in FIGS. 3-5. It is noted, however, that this environment is provided solely for illustrative purposes, and is not limiting. Embodiments of this disclosure may be implemented using and/or may be part of environments different from and/or in addition to the remote deposit system, as will be appreciated by persons skilled in the relevant art(s) based on the teachings contained herein.

Variations of the devices disclosed herein are contemplated. For example, in a computing device with a camera, such as a smartphone or tablet, multiple cameras (each of which may have its own image sensor or which may share one or more image sensors) or camera lenses may be implemented to process imagery. For example, a smartphone may implement three cameras, each of which has a lens system and an image sensor. Each image sensor may be the same or the cameras may include different image sensors (e.g., every image sensor is 24 MP; the first camera has a 24 MP image sensor, the second camera has a 24 MP image sensor, and the third camera has a 12 MP image sensor; etc.). In the first camera, a first lens may be dedicated to imaging applications that can benefit from a longer focal length than standard lenses. For example, a telephoto lens generates a narrow field of view and a magnified image. In the second camera, a second lens may be dedicated to imaging applications that can benefit from wide images. For example, a wide lens may include a wider field-of-view to generate imagery with elongated features, while making closer objects appear larger. In the third camera, a third lens may be dedicated to imaging applications that can benefit from an ultra-wide field of view. For example, an ultra-wide lens may generate a field of view that includes a larger portion of an object or objects located within a user's environment. The individual lenses may work separately or in combination to provide a versatile image processing capability for the computing device. While described for three differing cameras or lenses, the number of cameras or lenses may vary, to include duplicate cameras or lenses, without departing from the scope of the technologies disclosed herein. In addition, the focal lengths of the lenses may be varied, the lenses may be grouped in any configuration, and they may be distributed along any surface, for example, a front surface and/or back surface of the computing device.

In one non-limiting example, active OCR processes may benefit from image object builds generated by one or more, or a combination of cameras or lenses. For example, multiple cameras or lenses may separately, or in combination, capture specific blocks of imagery for data fields located within a document that is present, at least in part, within the field of view of the cameras. In another example, multiple cameras or lenses may capture more light than a single camera or lens, resulting in better image quality. In another example, individual lenses, or a combination of lenses, may generate depth data for one or more objects located within a field of view of the camera.

An example of the remote deposit system shall now be described.

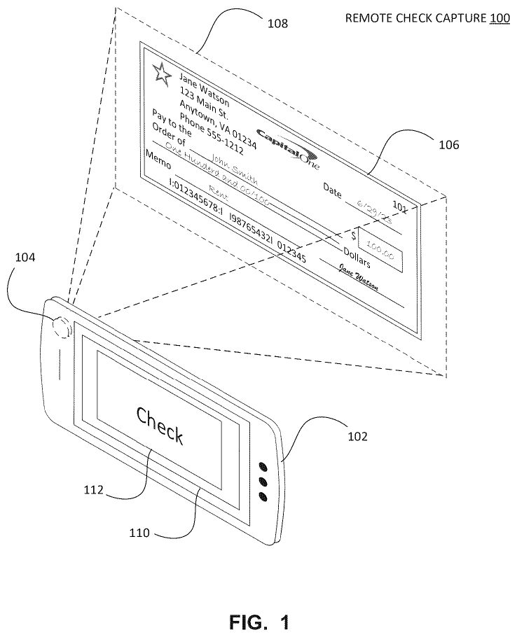

FIG. 1 illustrates an example remote check capture 100, according to some embodiments. Operations described may be implemented by processing logic that may include hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106 may be a personal check, paycheck, or government check, to name a few. In some embodiments, a customer may initiate a remote check capture 100 from their mobile computing device (e.g., smartphone) 102, but other digital camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc.) may be substituted without departing from the scope of the technology disclosed herein. For example, when the document to be deposited is a personal check, the customer may select a customer account at the bank account (e.g., checking or savings) into which the funds specified by the check are to be deposited. Content associated with the document may include the funds or monetary amount to be deposited to the customer account, the issuing bank, the routing number, and the account number. Content associated with the customer account may include a risk profile associated with the account and the current balance of the account. Options associated with a remote deposit process may include continuing with the deposit process or cancelling the deposit process, thereby cancelling depositing the check amount into the account.

Mobile computing device 102 may communicate with a bank or third party using a communication or network interface (not shown). The communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer may login to their mobile banking app, select the account they want to deposit a check into, then select, for example, a “deposit check” option that will activate their mobile device's camera 104 (e.g., activate the camera). One skilled in the art would understand that variations of this approach or functionally equivalent alternative approaches may be substituted to initiate a mobile deposit.

Using camera 104 on the mobile computing device 102, the customer may capture live imagery from a field of view 108 that includes at least a portion of one side of a check 106. Typically, the camera's field of view 108 will include at least the perimeter of the check 106. However, any camera position that generates in-focus check imagery 112 of the various data fields located on a check may be considered. Resolution, distance, alignment, and lighting parameters may require movement of the mobile device until a proper view of a complete check, in-focus, has occurred. An application (e.g., mobile banking app 304) running on mobile computing device 102 may offer suggestions or technical assistance to guide a proper framing of a check within the mobile banking app's graphically displayed field of view window 110, displayed on a user interface (UI) instantiated by the mobile banking app. A person skilled in the art of remote deposit would be aware of common requirements and limitations and would understand that different approaches may be required based on the environment in which the check viewing occurs. For example, poor lighting or reflections may require specific alternative techniques. As such, any known or future viewing or capture techniques are considered to be within the scope of the technology described herein. Alternatively, the camera can be remote to the mobile computing device 102. In an alternative embodiment, the remote deposit may implemented on a desktop computing device with an accompanying digital camera.

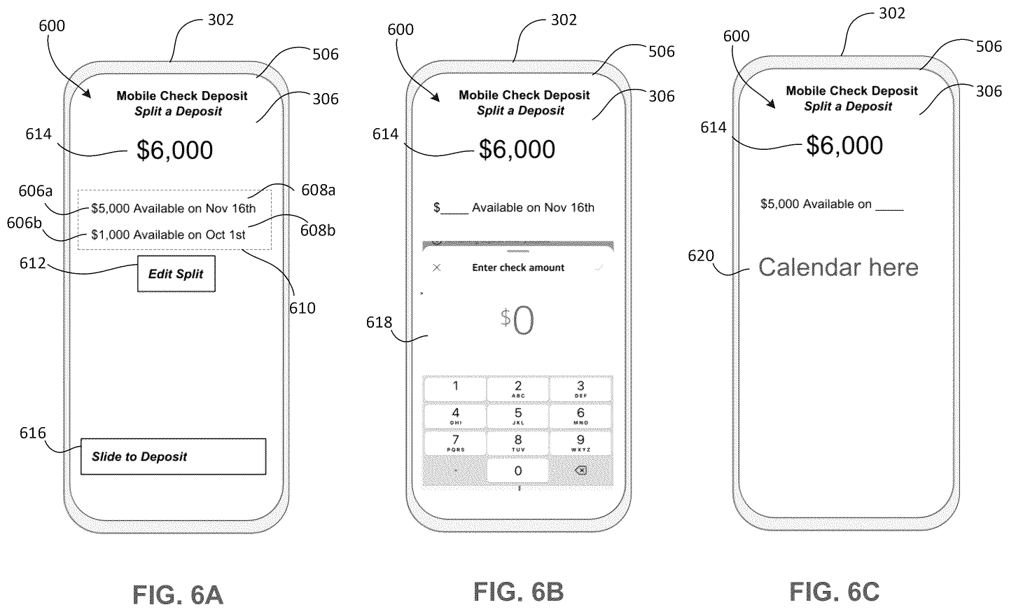

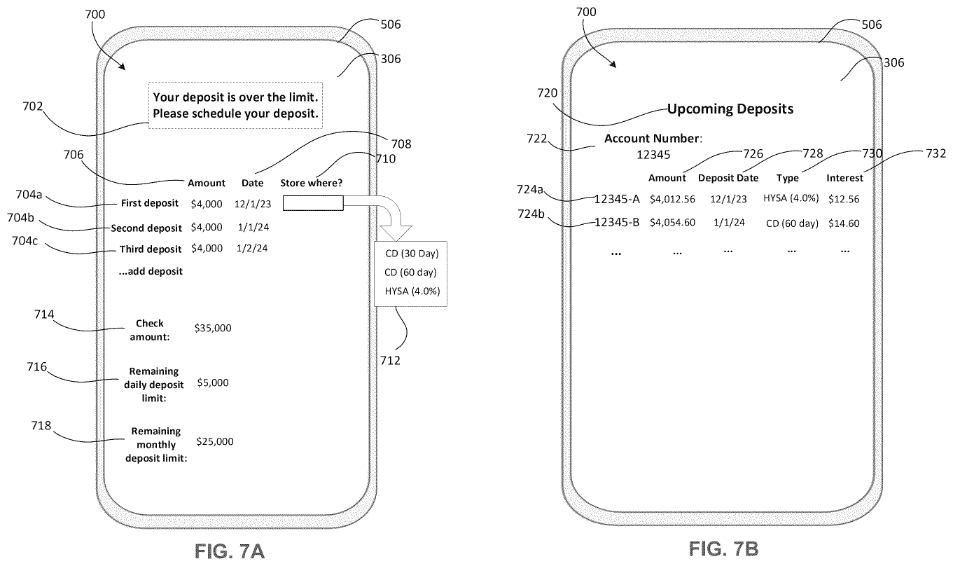

Sample customer instructions may include, but are not limited to, “Once you've completed filling out the check information and signed the back, it's time to view your check,” “For best results, place your check on a flat, dark-background surface to improve clarity,” “Make sure all four corners of the check fit within the on-screen frame to avoid any processing holdups,” “Select the camera icon in your mobile app to open the camera,” “Once you've viewed a clear image of the front of the check, repeat the process on the back of the check,” “Swipe the Slide to Deposit button to submit the deposit,” “Your deposit request may have gone through, but it's still a good idea to hold on to your check for a few days,” and “After the deposit is confirmed, you can safely destroy the check.” These instructions are provided as sample instructions or comments but any instructions or comments that guide the customer through a remote deposit session may be included. For example, deposit split and deposit scheduling instruments may additionally or alternatively be provided, as discussed with respect to FIGS. 6A-6C and FIGS. 7A-7B,

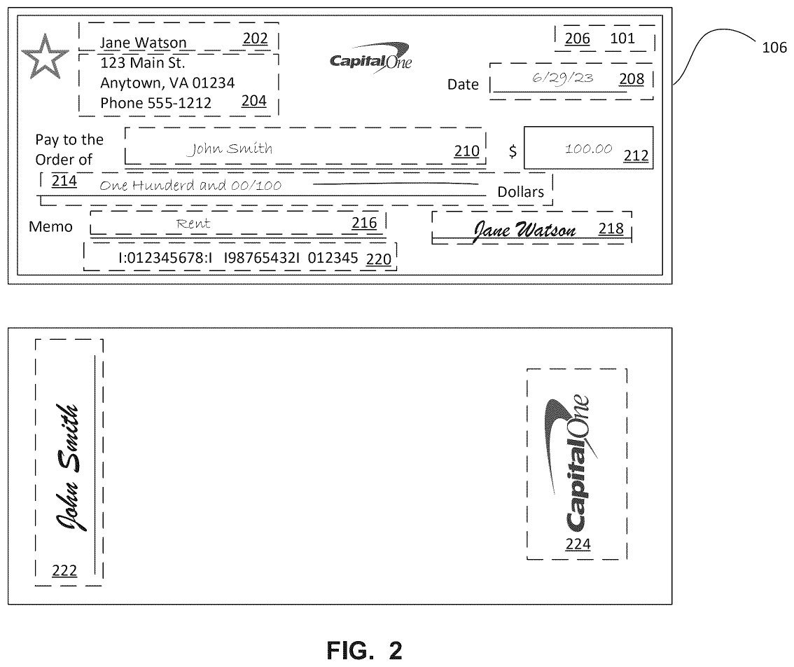

FIG. 2 illustrates example remote deposit OCR segmentation, according to some embodiments and aspects. Depending on check type, a check may have a fixed number of identifiable fields. For example, a standard personal check may have front side fields, such as, but not limited to, a payer name 202 and address 204, check number 206, date 208, payee field 210, payment amount 212, a written amount 214, memo line 216, Magnetic Ink Character Recognition (MICR) line 220 that includes a string of characters including the bank routing number, the payer's account number, and the check number, and the payer's signature 218. Back side identifiable fields may include, but are not limited to, payee signature 222 and security fields 224 (e.g., a watermark).

While a number of fields have been described, this description is not intended to limit the technology disclosed herein to these specific fields, as a check may have more or less identifiable fields than disclosed herein. In addition, security measures may include alternative approaches discoverable on the front side or back side of the check or discoverable by processing of identified information. For example, the remote deposit feature in the mobile banking app running on the mobile computing device 102 may determine whether the payment amount 212 and the written amount 214 are the same. Additional processing may be needed to determine a final amount to process the check if the two amounts are inconsistent. In one non-limiting example, the written amount 214 may supersede any amount identified within the amount field 212.

In some embodiments, active OCR processing of a stream of check imagery may include implementing instructions resident on the customer's mobile device to process each of the field locations on the check as they are detected or systematically (e.g., ordered list extracted from a Byte Array Output Stream object). For example, the streaming check imagery may reflect a field of view pixel scan from left-to-right or from top-to-bottom with data fields identified within a frame of the check as they are streamed. In some embodiments, the customer may hold their smartphone over a check (or checks) to be deposited remotely while the streaming field of view imagery is continuously processed via OCR until data from each of required data fields has been extracted.

In some embodiments, the live streamed image data may be assembled into one or more frames of image content. In some embodiments, a data signal from a camera sensor (e.g., CCD or an active-pixel sensor such as a complementary metal-oxide-semiconductor (CMOS) image sensor) may notify the banking app when an entire sensor has been read out as streamed data. In this approach, the camera sensor may be cleared of electrons before a subsequent exposure to light and a next frame of an image is captured. This clearing function may be conveyed to the mobile banking app, or the OCR system, to indicate that the Byte Array Output Stream object constitutes a complete frame of image data. In some embodiments, the images formed into a byte array may be first rectified to correct for distortions based on an angle of incidence, may be rotated to align the imagery, may be filtered to remove obstructions or reflections, and may be resized to correct for size distortions using known image processing techniques. In some embodiments, these corrections may be based on recognition of corners or borders of the check as a basis for image orientation and size, as is known in the art.

While any portion of a byte array may be processed via OCR during data field captures, in some embodiments, a Byte Array Output Stream object of an entire frame, or multiple frames, may be processed via OCR sequentially until all data fields have been extracted. For example, five data fields may be extracted from a first Byte Array Output Stream object, while the remaining data fields may be extracted from one or more subsequent Byte Array Output Stream objects. Extracting data fields from a plurality of byte array output stream objects is further described in U.S. application Ser. No. 18/503,799, filed Nov. 7, 2023 and titled “INTELLIGENT DOCUMENT FIELD EXTRACTION FROM MULTIPLE IMAGE OBJECTS,” the disclosure of which is incorporated by reference herein in its entirety. The extraction process may include sequentially OCR processing the byte array objects based on a highest image quality using confidence scores. Alternatively, or in addition, a Byte Array Output Stream object of multiple frames may be graphically overlaid (e.g., in a multi-layer image buffer) or virtually overlaid (e.g., in a virtual image buffer) to form a blended image and processed via OCR until all data fields have been extracted. For example, content from common pixels, from each image frame, may be weighted and aggregated to form a blended image of at least a threshold level of quality prior to the OCR process. This composite build process is further described in U.S. application Ser. No. 18/503,787, filed Nov. 7, 2023 and titled “BURST IMAGE CAPTURE,” the disclosure of which is incorporated by reference herein in its entirety.

In some embodiments, fields that include typed information, such as the MICR line 220, check number 206, payer name 202, and address 204, etc., may be processed via OCR first from the Byte Array Output Stream object, followed by a more complex or time intensive OCR process of identifying written fields, such as the payee field 210, signature 218, to name a few.

In some embodiments, artificial intelligence (AI), such as machine-learning (ML) systems may train an OCR model(s) to recognize characters, numerals, or other check data within the data fields of the streamed imagery. The OCR model may be resident on mobile computing device 102 and may be integrated with or be separate from the mobile banking application. The OCR model may be continuously updated by future transactions used to train the OCR model(s). ML involves computers discovering how they can perform tasks without being explicitly programmed to do so. ML includes, but is not limited to, artificial intelligence, deep learning, fuzzy learning, supervised learning, unsupervised learning, etc. Machine learning algorithms build a model based on sample data, known as “training data,” to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

A machine-learning engine may use various classifiers to map concepts associated with a specific OCR process to capture relationships between concepts (e.g., image clarity vs. recognition of specific characters or numerals) and an OCR success history. The classifier (discriminator) may be trained to distinguish (recognize) variations. Different variations may be classified to ensure no collapse of the classifier and so that variations can be distinguished.

In some embodiments, machine learning models are trained on a remote machine learning platform (e.g., see FIG. 3, element 329) using other customer's transactional information (e.g., previous OCR data extractions). In addition, large training sets of the other customer's historical information may be used to normalize prediction data (e.g., not skewed by a single or few occurrences of a data artifact). Thereafter, an OCR predictive model(s) may classify a specific OCR data field extraction against the trained predictive model to predict required imagery quality and generate or enhance a previous generated OCR query based on provided metadata (resolution, focal length, etc.). In some embodiments, the OCR models are continuously updated as new financial transactions occur.

In some embodiments, a ML engine may continuously change weighting of model inputs to increase customer interactions with the OCR procedures. For example, weighting of specific data fields may be continuously modified in the model to trend towards greater success, where success is recognized by correct data field extractions or by completed remote deposit transactions. Conversely, term weighting that lowers successful OCR interactions may be lowered or eliminated.

FIG. 3 illustrates a remote deposit system 300, according to some embodiments. Operations described may be implemented by processing logic that may include hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) may implement remote deposit processing for one or more financial instruments, such as checks. The client device 302 may be configured to communicate with a cloud banking system 316 to complete various phases of a remote deposit as will be discussed in greater detail hereafter.

In some embodiments, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 can communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking app 304 may be a computer program or software application designed to run on a mobile device such as a phone, tablet, or watch. However, in a desktop application, a desktop equivalent of the mobile banking app may be configured to run on desktop computers, and web applications, which run in mobile web browsers rather than directly on a mobile device. Applications or apps may be broadly classified into three types: native apps, hybrid, and web apps. Native applications may be designed specifically for a mobile operating system, typically iOS or Android. Web apps may be designed to be accessed through a web browser. Hybrid apps may be built using web technologies such as JavaScript, CSS, and HTML5 and may function like web apps disguised in a native container.

Financial instrument imagery may originate from any of, but not limited to, image streams (e.g., series of pixels or frames) or video streams or a combination of any of these or future image formats. A customer using a client device 302, operating a mobile banking app 304 through an interactive UI 306, may frame at least a portion of a check (e.g., identifiable fields on front or back of check) with a camera 308 (e.g., field of view). In some embodiments, imagery may be processed from camera 308, as a live stream communicated from camera 308 over a period of time, until an active OCR operation has been completed. In some embodiments, the camera imagery may be streamed as encoded text, such as a byte array. Alternatively, or in addition, the live imagery may be buffered by storing (e.g., at least temporarily) as images or frames in computer memory. For example, live streamed check imagery may be stored locally in image memory 312, which may be, but is not limited to, a frame buffer, a video buffer, a streaming buffer, or a virtual buffer.

Active OCR system 310, resident on the client device 302, may processes the live streamed check imagery from camera 308 to extract data by identifying specific data located within known sections of the check to be electronically deposited. In some embodiments, single identifiable fields, such as the payer name 202, MICR line 220 identifying customer and bank information (e.g., bank name, bank routing number, customer account number, and check number), date field 208, payment amount 212 and written amount 214, and authentication (e.g., payee signature 222) and security fields 224 (e.g., watermark), etc. are processed by the active OCR system 310. In some embodiments, the active OCR process is completed before finalization of a remote deposit operation.

Account identification 314 may use single or multiple level login data from mobile banking app 304 to initiate a remote deposit. Alternately, or in addition, the extracted payee field 210 or the payee signature 222 may be used to provide additional authentication of the customer.

Active OCR system 310 may communicate data extracted from the one or more data fields during the active OCR operation to cloud banking system 316. For example, the extracted data identified within these fields may be communicated to file database (DB) 320 either through a mobile app server 332 or mobile web server 334 depending on the configuration of the client device (e.g., mobile or desktop). In some embodiments, the extracted data identified within these fields is communicated through the mobile banking app 304.

Alternatively, or in addition, a thin client (not shown) resident on the client device 302 may process extracted fields locally with assistance from cloud banking system 316. For example, a processor (e.g., CPU) may implement at least a portion of remote deposit functionality using resources stored on a remote server instead of a localized memory. The thin client may connect remotely to the server-based computing environment (e.g., cloud banking system 316) where applications, sensitive data, and memory may be stored.

Backend 322 may include one or more system servers processing banking deposit operations in a secure environment. These one or more system servers may operate to support client device 302. API 318 may be an intermediary software interface between mobile banking app 304, installed on client device 302, and one or more server systems, such as, but not limited to the backend 322, as well as third party servers (not shown). The API 318 may be available to be called by mobile clients through a server, such as a mobile edge server (not shown), within cloud banking system 316. File DB 320 may store files received from the client device 302 or generated as a result of processing a remote deposit.

Profile module 324 may retrieve customer profiles associated with the customer from a registry after extracting customer data from front or back images of the financial instrument. Customer profiles may be used to determine deposit limits, historical activity, security data, or other customer related data.

Validation module 326 may generate a set of validations including, but not limited to, any of: mobile deposit eligibility, account, image, transaction limits, duplicate checks, amount mismatch, MICR, multiple deposit, etc. While shown as a single module, the various validations may be performed by, or in conjunction with, the client device 302, cloud banking system 316, or third party systems or data.

Customer accounts 328 (consistent with customer account 408) may include, but is not limited to, a customer's financial banking information, such as individual, joint, or commercial account information, balances, loans, credit cards, account historical data, etc.

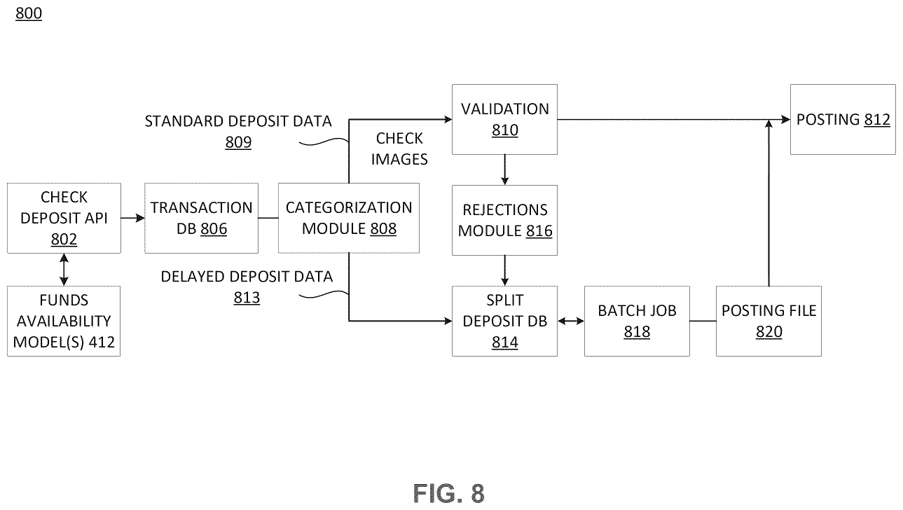

ML platform 329 may include a trained OCR model or an ML engine to train an OCR model(s) used to extract and process OCR data. This disclosure is not intended to limit the ML platform 329 to only OCR model generation as it may also include, but not be limited to, remote deposit models, risk models, funding models, security models, etc., as described herein. For example, in some embodiments, ML platform 329 may include one or more trained funds availability models that may receive inputs and provide outputs to mobile banking app 304 (e.g., via mobile app server 332 and/or API 318). The outputs may be related to available deposit splits and deposit schedules. Mobile banking app 304 may use the outputs to generate and display a split deposit and deposit scheduling tool via user interface (UI 306), as described with respect to FIGS. 6A-6C and FIG. 8.

When remote deposit status information is generated, it may be passed back to the client device 302 through API 318 where it may be formatted for communication and display on the client device 302 and may, for example, communicate a deposit split and deposit schedule confirmation or rejection for display or rendering on the customer's device through the mobile banking app UI 306. The UI may instantiate the confirmation or rejection as images, graphics, audio, additional content, etc.

Pending deposit 330 may include a profile of a potential upcoming deposit(s) based on an acceptance or selection by the customer through UI 306 of a deposit according to given terms. If initial validation of the selected deposit is successful, pending deposit 330 may create a record for the transaction and this function may retrieve a product type associated with the account, retrieve the interactions, and create a pending check deposit activity.

Deposit retention module 336 may manage deposit retention vehicles for upcoming deposits that have been scheduled as described herein. Deposit retention module 336 may keep track of upcoming deposit amounts, upcoming deposit dates, the type of deposit retention vehicle in which an upcoming deposit is being stored, and interest accrued.

Alternatively, or in addition, to the component arrangements described above, one or more components of the remote deposit process may be implemented within the client device 302, third party platforms, the cloud-based banking system 316, or distributed across multiple computer-based systems.

In some embodiments, remote deposit system 300 may track customer behavior. For example, did the customer complete a remote deposit operation or did they cancel the request? In some embodiments, the completion of the remote deposit operation reflects a successful outcome, while a cancellation reflects a failed outcome. In some embodiments, this customer behavior, not limited to success/failure, may be fed back to the ML platform 329 to enhance future training of a remote deposit model (e.g., a funds availability model as described herein). For example, in some embodiments, one or more inputs to the ML remote deposit models may be weighted differently (higher or lower) to effect a predicted higher successful outcome.

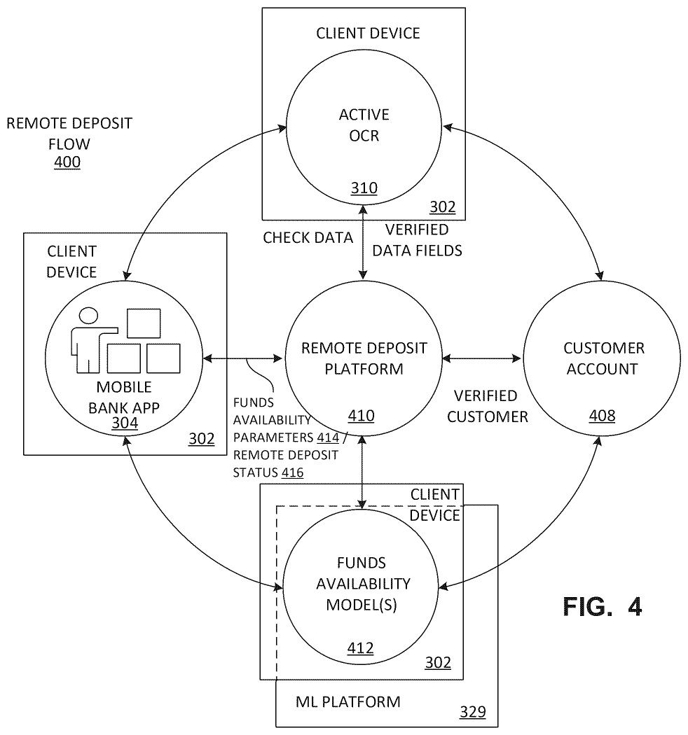

FIG. 4 illustrates an example flow diagram of a remote deposit system, according to some embodiments and aspects. The remote deposit flow 400 may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that may include hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In some embodiments, a bank customer using a client device 302 (e.g., mobile computing device 102), operating a mobile banking app 304, may frame at least a portion of a check within a field of view from an active camera (e.g., camera activated) of client device 302. As previously described, the imagery within the field of view may, in some embodiments, be configured as a live stream. In some embodiments, the camera imagery is streamed as encoded text, such as a byte array (e.g., as a Byte Array Output Stream object). This live stream of image data may be processed, without requiring an image capture to be communicated to a remote deposit server, using a client device resident active OCR system 310 (e.g., program or ML model). Active OCR may be defined as performing OCR on a live stream of image data within a current customer transaction time period. The active OCR may generate data from a plurality of fields of the check. For example, the active OCR may extract or identify a check date, check number, payer, payee, amount, payee information, and bank information, to name a few.

While extracting identifiable data from surfaces of the check is a primary output of the active OCR, additional post-processing may be needed to further confirm or verify the data. Additional post active OCR processing may include, but is not limited to, verification of data extracted from the fields based on a comparison with historical customer account data found in the customer's account 408 or the payer's account. The customer account 408, for purposes of description, may be the payee's account, the payer's account or both. For example, a payee's account historical information may be used to calculate a payee's funds availability parameters 414, while a payer's account may be checked for funds to cover the check amount. In some embodiments, an address may be checked against the current address found in a data file of customer account 408. In some embodiments, post active OCR processing may include checking a signature file within customer account 408 to verify the payee or payer signatures. It is also contemplated that a third party database can be checked for funds and signatures for checks from payers not associated with the payee customer's bank. Additional known OCR post processing techniques may be substituted without departing from the scope of the technology described herein.

Remote deposit platform may 410 receive the extracted data fields of the check from the client device 302. In some embodiments, single identifiable fields, such as the check number 206, date field 208, payee field 210, amount field 212, etc. may be sequentially communicated by the active OCR system 310 and communicated in real-time as they are detected and processed via OCR. For example, the MICR line 220 that includes a string of characters including the bank routing number and the payer's account number may be processed before other fields to immediately initiate a verification of the payer, while the active OCR processes the remaining fields. In some embodiments, the amount fields may be processed to initiate a funds availability process before the remaining data fields have been extracted. Alternatively, or in addition, the active OCR process may have a time ordered sequence of fields to be processed. Alternatively, or in addition, all identifiable check fields may be processed simultaneously in parallel by the active OCR system 310.

Active OCR system 310 may communicate one or more data fields extracted in the OCR operation to a funds availability model(s) 412. For example, active OCR system 310 may communicate customer data (e.g., name, address, account number, bank information (e.g., routing information), check number, check amount (e.g., funding amount needed), authorization, and anti-fraud information (e.g., signature verifications, watermark or other check security imagery), or a combination thereof. Funds availability model(s) 412 may return fixed or dynamically modifiable funds availability parameters 414 that may be communicated to mobile banking app 304, which may generate allowed deposit splits and deposit schedules based on funds availability parameters 414. After the payee customer has selected a deposit split and deposit schedule, funds availability model(s) 412 may also verify the deposit split and deposit schedule and provide a remote deposit status 416 to mobile banking app 304 for display on UI 306 of the client device 302. The remote deposit status 416 may indicate to the user whether the selected deposit split and deposit schedule has been confirmed or rejected.

In some embodiments, client device 302 may also obtain check images using a camera 308 (e.g., camera 104). The check images, including the front and back of the check, may be transmitted along with the active OCR data. The check images may then be stored in the customer account 408 for later use if necessary. However, in some embodiments, the processing of the active OCR data may be independent of the check images taken by the camera 308. In other words, in some embodiments, the check deposit may be completed without processing the check images.

Remote deposit platform 410 (e.g., using funds availability model(s) 412) may compute funds availability parameters 414 based on one or more of the received data fields, customer history received from the customer's account 408, bank funding policies, legal requirements (e.g., state or federally mandated limits and reporting requirements, etc.), or typical schedules stored within funds availability model(s) 412, to name a few. For example, the active OCR system 310 may identify the MICR data as a verified data field that may be used to access a payer customer's account 408. This access may allow the bank identified in the MICR to provide a history of the payer customer's account 408 to remote deposit platform 410 for use by funds availability model(s) 412. Early access to the payer customer's account may also provide a verified customer for security purposes to eliminate or reduce fraud early in the remote deposit process.

Remote deposit platform 410 may communicate funds availability parameters 414 to the customer's device. In some embodiments, the funds availability parameters 414 may include allowed deposit dates and/or allowed deposit amounts. For example, in some embodiments, the funds availability parameters 414 may map a selected amount to one or more available deposit dates. Accordingly, in some embodiments, if a payee customer selects an amount for deposit, mobile banking app 304 may communicate the selected amount to funds availability model(s) 412, which may provide a list of available dates (based on remote deposit limits). Mobile banking app 304 may receive the list of available dates and use the list to determine what dates are displayed to the payee customer as available dates for deposit scheduling. In some embodiments, funds availability model(s) 412 may predetermine, based on payment amount 212 determined via OCR processing, what dates are available for deposit completion given one or more fractional amounts of the check amount, such that the funds availability parameters 414 may include built in logic that mobile banking app 304 may use to determine available deposit dates without intermediate communication with funds availability model(s) 412.

After the payee customer has selected a deposit split and deposit schedule, funds availability model(s) 412 may also verify the deposit split and deposit schedule and provide (e.g., via remote deposit platform 410) a remote deposit status 416 to mobile banking app 304 for rendering on UI 306 of the client device 302. The remote deposit status 416 may indicate to the user whether the selected deposit split and deposit schedule has been confirmed or rejected. The rendering of remote deposit status 416 may include imagery, text, or a link to additional content. The UI 306 may instantiate the remote deposit status 416 as images, graphics, audio, etc. In one technical improvement over current processing systems, the remote deposit status 416 may be provided mid-stream, prior to completion of the deposit submission. In this approach, the customer may terminate the process prior to completion if they are dissatisfied with the remote deposit status 416.

The verification of the selected deposit split and deposit schedule may be useful when a simple funds availability model 412 (e.g., a rule-based model) is used to determine amounts and dates that are available to the user for scheduling (e.g., using logic that considers amount and remaining deposit limits to determine available dates). In such embodiments, one or more complex funds availability models 412 (e.g., ML model(s)) may be used to verify the customer's selection by determining whether the selected deposit split and deposit schedule poses a risk of fraud or an unsuccessful deposit, based on various other data (e.g., payee customer historical data, payer data, other check fields, check image features, etc.). In some embodiments, the simple funds availability model 412 may operate at client device 302 as part of mobile banking app 304. In some embodiments, the one or more complex funds availability models 412 may operate at ML platform 329.

In some embodiments, remote deposit platform 410 may track customer behavior. For example, did the customer complete a remote deposit operation or did they cancel the request? In some embodiments, the completion of the remote deposit operation reflects a successful outcome, while a cancellation reflects a failed outcome. In some aspects, this customer behavior, not limited to success/failure, may be fed back to ML platform 329 communicating with remote deposit platform 410 to enhance future training of a ML OCR model or a ML funds availability model 412. For example, in some embodiments, one or more inputs to the ML funds availability model 412 may be weighted differently (higher or lower) to effect a predicted higher successful outcome.

Alternatively, or in addition, one or more components or procedures of remote deposit flow 400 may be implemented within the customer device, third party platforms, and a cloud-based system or distributed across multiple computer-based systems.

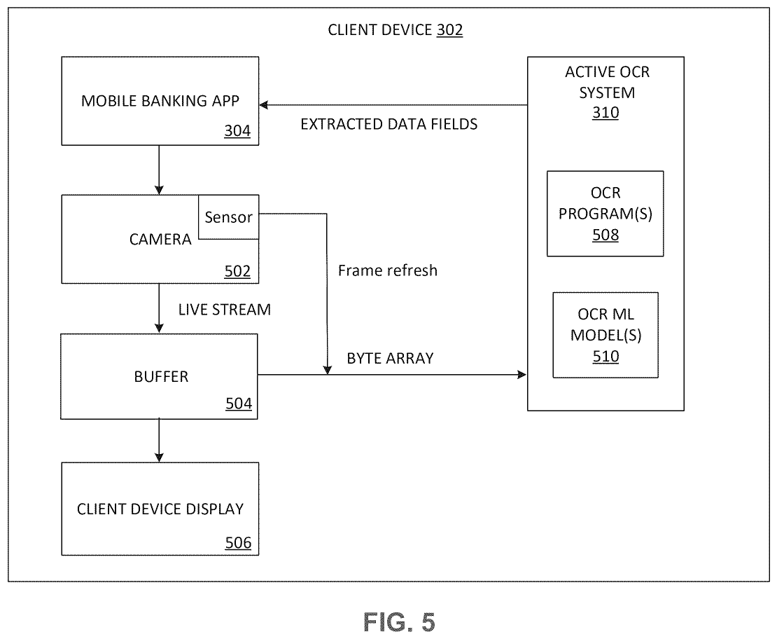

FIG. 5 illustrates an example diagram of a client device 302, according to some embodiments. Operations described may be implemented by processing logic that may include hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In some embodiments, the mobile banking app 304 may be opened on the client device 302 and the deposit check function selected to initiate a remote deposit process. A camera may be activated (e.g., camera 502) to communicate a live stream of imagery (e.g., frames of video) from a field of view of the camera 502. A camera may output, for display at client display device 506, a frame (e.g., an image frame or a frame of a video, for example) having one or more images (e.g., images of real-world objects) that are viewable by camera 502. An image frame may include one or more images that may represent one or more real-world objects. For instance, an image may represent an entire group of checks in a field of view of camera 502, or the image may represent one or more individual objects within the group. In some embodiments, the image of decodable check indicia can be provided by a raw image byte stream or by a byte array, a compressed image byte stream or byte array, and/or a partial compressed image byte stream or byte array.

The customer of the client device 302 may view the live stream of imagery on a UI of the client device display 506, after buffering in buffer 504 (e.g., frame buffer, video buffer, etc.). In some embodiments, the live stream is communicated to the active OCR as a raw image live stream. In some aspects, the raw image live stream is first converted to a byte array and then communicated to the active OCR system 310 (buffered or not buffered). The data embedded in the byte stream or byte array may then extracted by program instructions of an OCR program(s) 508 of active OCR system 310 and may be saved to memory of the client device 302. This extracted data may be continuously transmitted, periodically transmitted, or may be transmitted after completion of the active OCR (e.g., after all data fields are extracted), as check data fields to a cloud banking system 316 via a network connection. Mobile banking app 304 may also receive and/or access the extracted data.

In some embodiments, the front side imagery may be processed followed by the back side imagery. Alternatively, in some embodiments, the front side and back side imagery may be processed together or in parallel.

In some embodiments, the remote deposit platform 410, as described in FIG. 4, may be used to assist implementation of the localized mobile device active OCR processing. For example, in some embodiments, computer vision algorithms may use large language models (LLM). A large language model is a language model characterized by emergent properties enabled by its large size. As language models, they work by taking an input text and repeatedly predicting the next token or word. They are built with artificial neural networks, pre-trained using self-supervised learning and semi-supervised learning, typically containing tens of millions to billions of weights. In some embodiments, LLM includes Natural Language Processing (NLP). One goal is a computer capable of “understanding” the contents of images, including the contextual nuances of the language within them. The technology can then accurately extract information and insights contained in the images as well as categorize and organize the images or fields within images themselves. LLM and NLP functionality may be implemented on the ML platform 329 to train and improve OCR ML model(s) 510 that may be operate on client device 302 for the localized active OCR processing.

The technical solution disclosed above allows active OCR processing of live imagery, without first requiring an image capture, communication thereof and remote OCR processing of a captured image. This solution set accelerates the remote check deposit process and allows mid-stream alterations or improvements, for example, real-time provision of a split deposit and deposit scheduling tool, based on a check amount determined using OCR. While on-device active OCR is described, other real-time OCR methods may be used to achieve the same or similar effect, for example, real-time communication of image data off-device for instant OCR processing using OCR programs or OCR ML models operating on cloud banking system 316 or a third-party server. Additionally, any form of OCR processing may be used, including traditional OCR processing. In some embodiments, the traditional OCR processing may be performed at client device 302. In some embodiments, the traditional OCR processing may be performed at cloud banking system 316 or a third-party server. In some embodiments, the traditional OCR processing need not be performed in real-time, and the split deposit and deposit schedule tool may be provided at any point during the deposit process (e.g., after a deposit request is submitted, after image processing at a backend server, etc.).

FIGS. 6A-6C depict a split deposit tool 600, according to some embodiments. Operations described may be implemented by processing logic that may include hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIGS. 6A-6C, as will be understood by a person of ordinary skill in the art.

As shown in FIGS. 6A-6C, split deposit tool 600 may be provided to a customer via user interface 306 of client device 302, instantiated on client device display 506. Split deposit tool 600 may be provided to the customer after the customer has selected an account into which the customer would like to deposit a check and has completed the check image capture process. In some embodiments, mobile banking app 304 may display split deposit tool 600 upon completion of image capture for a remote deposit session by a customer, regardless of the amount associated with the check depicted in the image(s). In such embodiments, the customer may select a deposit split and deposit schedule for every transaction, unless the customer decides to toggle off split deposit tool 600 within mobile banking app 304. Such embodiments may allow the customer greater control over when the customer has access to deposited funds, which can be advantageous for budgeting or planning purposes.

In some embodiments, mobile banking app 304 may display split deposit tool 600 in response to a check image exceeding a remaining remote deposit limit. The remaining remote deposit limit may be an amount limit within a timeframe (e.g., a maximum remote deposit amount per day, week, month, or year). Alternatively, or in addition, the remaining remote deposit limit may be a limit on the number of checks submitted for remote deposit within a timeframe (e.g., a maximum number of checks per day, week, month, or year).

In some embodiments, mobile banking app 304 may display split deposit tool 600 in response to an amount associated with a check image exceeding a remaining remote deposit limit. In such embodiments, the amount may be determined using real-time OCR according to any of the embodiments described herein. Alternatively, or in addition, the amount may be determined from a user input (e.g., an amount entered by the customer). The remaining remote deposit limit may be calculated by a funds availability model 412 (e.g., a limit assessment model as described with respect to FIG. 8), which may take into account user deposit history and remote deposit limits to calculate a remaining remote deposit amount available in a given timeframe. The funds availability model 412 (e.g., the limit assessment model) may compare the amount associated with the check image to the remaining remote deposit amount available in the given timeframe and determine whether the amount associated with the check image exceeds the remaining remote deposit amount available.

The amount associated with the check image (e.g., payment amount 212 and/or written amount 214, and/or an amount entered by the customer) may be displayed as a check amount 614 by split deposit tool 600. As shown in FIG. 6A, in some embodiments, split deposit tool 600 may also display a split deposit status 610. In some embodiments, split deposit status 610 may identify a first split amount 606a and a first split date 608a. Likewise, split deposit status 610 may identify a second split amount 606b and a second split date 608b. In some embodiments, second split amount 606b may indicate the maximum remaining remote deposit funds available before a remote deposit limit is met for the current time period (e.g., day, week, month, etc.). In some embodiments, second split date 608b may be the date the customer is attempting to deposit the check. In some embodiments, second split date 608b may be a date calculated using on or more ML funds availability models 412 that has/have determined the nearest date funds may be released to the customer. In some embodiments, first split amount 606a may indicate the maximum remaining remote deposit funds available before a remote deposit limit is met for an upcoming time period (e.g., next day, next week, next month, etc.). In some embodiments, first split date 608a may be the date the upcoming time period begins. In some embodiments, split deposit status 610 may be generated by mobile banking app 304 based on funds availability parameters 414 received from funds availability model(s) 412, which may have been determined based on check amount 614.

In some embodiments, split deposit tool 600 may include an edit split function 612. Edit split function 612 may allow the customer to select a first portion of check amount 614 (as shown in FIG. 6B using amount selection function 618) to be deposited at a first date (as shown in FIG. 6C using date selection function 620). Likewise, the edit split function 612 may allow the customer to select a second portion of check amount 614 to be deposited at a second date different from the first date (again, using amount selection function 618 and date selection function 620). In some embodiments, edit split function 612 may allow the customer to select a third, fourth, fifth portion, etc. and third, fourth, fifth dates, etc. (i.e., in some embodiments, the customer may divide check amount 614 into as many different deposits as desired, as shown in FIG. 7A).

In some embodiments, amount selection function 618 may be in the form of an onscreen number pad allowing a customer to enter an amount via a touchscreen of client device display 506. In some embodiments, date selection function 620 may be a calendar allowing a customer to select a date via the touchscreen of client device display 506. In some embodiments, one or more funds availability models 412 may operate in real-time (on client device 302 and/or at cloud banking system 316) to provide feedback to the customer regarding selected amounts and/or dates. For example, the one or more funds availability models 412 may receive an amount entered by the user via amount selection function 618 and may determine which dates are available for deposit, based on the amount, known deposit limits, and in some cases customer deposit history and/or risk factors associated with the check image (e.g., if one or more ML models are implemented). Mobile banking app 304 may use the information on available dates determined by the one or more funds availability models 412 to grey out dates on date selection function 620 that are not available. Similarly, the same or a different funds availability model 412 may determine that the amount entered by the user exceeds check amount 614. Mobile banking app 304 may provide an error message to the customer in real-time instructing the customer to select an amount equal to or below check amount 614.

In some embodiments, funds availability model(s) 412 may include simple rule-based logic operating as part of mobile banking app 304. Additionally or alternatively, funds availability model(s) 412 may include one or more ML models operating either on client device 302 or on ML platform 329. The features of funds availability model(s) 412 will be discussed in more detail with respect to FIG. 8.

While FIGS. 6B and 6C show a number pad and a calendar being implemented for amount selection function 618 and date selection function 620, respectively, any known methods for entering an amount and date may be implemented. For example, amount selection function 618 may allow a customer to select an amount from a list of predetermined available amounts, selected by mobile banking app 304 based on an output from funds availability model(s) 412. Likewise, as an example, date selection function 620 may include a number pad for manual date entry by a user, and mobile banking app 304 may provide an error message to the customer in real-time if an entered date is not available, based the amount selected by the customer and the outputs of funds availability model(s) 412.

FIGS. 7A-7B depict a split deposit tool 700, according to alternative embodiments. Operations described may be implemented by processing logic that may include hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIGS. 7A-7B, as will be understood by a person of ordinary skill in the art.

Split deposit tool 700 may be displayed to a customer under the same conditions as those described above for split deposit tool 600. As shown in FIG. 7A, split deposit tool 700 may include user instructions request 702. User instructions request 702 may notify a customer that an attempted deposit exceeds a remaining deposit limit and may request that the customer schedule the deposit. Split deposit tool 700 may instruct a customer to schedule the deposit as one or more deposits, for example, first deposit 704a, second deposit 704b, third deposit 704c, etc. While three deposits are shown in FIG. 7A, any number of deposits greater than or equal to one (up to a limit determined by the bank providing mobile banking app 304) may be selected by the customer. Split deposit tool 700 may provide the option of adding a deposit, as shown in FIG. 7A.

Each of first, second, and third deposits 704a-c may include a deposit amount 706 and a deposit date 708. Available deposit amounts 706 and deposit dates 708 may be determined based on outputs of funds availability model(s) 412 (e.g., based on funds availability parameters 414), as described above with respect to FIGS. 6A-C. Deposit amount 706 of first deposit 704a may correspond to a first portion of a check amount 714, deposit amount 706 of second deposit 704b may correspond to a second portion of check amount 714, deposit amount 706 of third deposit 704c may correspond to a third portion of check amount 714, etc. Deposit date 708 of first deposit 704a may correspond to a date the first portion of check amount 714 will be deposited into the customer's account, deposit date 708 of second deposit 704b may correspond to a date the second portion of check amount 714 will be deposited into the customer's account, deposit date 708 of third deposit 704c may correspond to a date the third portion of check amount 714 will be deposited into the customer's account, etc. In some embodiments, deposit dates and deposit amounts may be selected by a customer by pressing the areas in which the amounts/dates will be shown on client device display 506 (the areas showing the amounts/dates in FIG. 7A), and entering the amounts/dates as described above for split deposit tool 600 (e.g., via number pad, calendar, selecting from a list, etc.).

In some embodiments, for the customer's reference, split deposit tool 700 may display a remaining deposit limit, for example, a remaining daily deposit limit 716 and/or a remaining monthly deposit limit 718.

In some embodiments, each of first, second, and third deposits 704a-c may additionally include a deposit storage location 710. Deposit storage location 710 may be a location a deposit is stored until a selected deposit date. In some embodiments, deposit storage location 710 may include a deposit retention vehicle 712. In some embodiments, deposit retention vehicle 712 may be a certificate of deposit (CD), a high-yield savings account (HYSA), a temporary account, a money market account, an investment account, a health savings account, a flexible spending account, a college savings account (e.g., a 529 plan), or any other type of known account. Whatever the type of deposit retention vehicle 712, deposit retention vehicle 712 may be configured such that the customer does not have access to funds stored in deposit retention vehicle 712 until the date selected by a user for a deposit to be completed, or, in some embodiments, the date the amount of the deposit no longer exceeds a remote deposit limit. In some embodiments, upon reaching the date selected by the user for the deposit to be completed, the funds stored in deposit retention vehicle 712 may be automatically released to the account into which the customer originally attempted to deposit the check associated with the funds. In some embodiments, the funds may remain in deposit retention vehicle 712 until the customer transfers the funds to the account into which the customer originally attempted to deposit the check associated with the funds, but an alert may be sent to the customer in mobile banking app 304 indicating that the funds are available for deposit.

As shown in FIG. 7B, in some embodiments, split deposit tool 700 may include an upcoming deposits page 720. Upcoming deposits page 720 may display a list of upcoming deposits for a given account 722. For example, upcoming deposits page 720 may display a first upcoming deposit 724a and a second upcoming deposit 724b. Any number of upcoming deposits may be displayed. In some embodiments, each of first and second upcoming deposits 724a-b may include an upcoming deposit amount 726 and an upcoming deposit date 728. In some embodiments, each of first and second upcoming deposits 724a-b may additionally include a deposit retention vehicle type 730 and optionally an interest 732. Deposit retention vehicle type 730 may be the type of deposit retention vehicle 712 in which an upcoming deposit is stored. Interest 732 may be the amount of interest gained on so far since the original upcoming deposit amount 726 was stored in the deposit retention vehicle 712. In some embodiments, interest 732 may be calculated from the date the upcoming deposit amount 726 would have been deposited into account 722 and available to the customer, had a remote deposit limit not prevented the deposit. In some embodiments, the date the upcoming deposit amount 726 would have been deposited into account 722 may be the date the image(s) of the check associated with upcoming deposit amount 726 cleared a validation process. In some embodiments, the date the upcoming deposit amount 726 would have been deposited into account 722 may be a date earlier than the date the image(s) of the check associated with upcoming deposit amount 726 cleared a validation process, as the customer may have been approved for early deposit access based on one or more funds availability model(s) 412 indicating the payee customer, the payer customer, and/or the image(s) were associated with a low risk of fraud or unsuccessful funds transfer.

In some embodiments, deposit retention vehicle 712 may be a temporary account. In such embodiments, deposit retention vehicle need not be any particular type of account (e.g., CD, HYSA, etc.), but may be a provisional account created specifically for the split deposit processes described herein. For example, deposit retention vehicle 712 may be a temporary account that expires on the date selected by the customer for a stored deposit to be completed, but that does not provide access to funds stored in the temporary account to the customer. In some embodiments, the temporary account may have an interest rate that is calculated based on past split deposit activity of the customer. For example, the interest rate may depend on the frequency of use of split deposit for a customer and/or the amounts of funds that are stored using split deposit. In some embodiments, the interest rate may be higher for those who use split deposit more regularly and/or temporarily store more funds, to reward customers who continue to use mobile banking app 304 despite encountering remote deposit limits. In some embodiments, the interest rate may be calculated based on the interest rate of the account into which the funds will eventually be deposited. The interest rate may be less than, the same, or more than the interest rate of the account into which the funds will eventually be deposited.

While the various examples have been provided above, it should be understood that a “deposit retention vehicle” refers to any digital storage location where deposit funds are recorded and tracked for deposit on a later date, whether or not information on the funds is displayed to the customer and whether or not interest is accrued.

In some embodiments, from upcoming deposits page 720, a customer may alter upcoming deposit amount 726 and/or upcoming deposit date 728. In some embodiments, the customer may only alter upcoming deposit amount 726 and or upcoming deposit date 728 to an amount/date that is available for completion of the deposit (i.e., does not violate any remote deposit limits). In such embodiments, the customer may alter the upcoming deposit amount 726 and/or the upcoming deposit date 728 by selecting and editing the upcoming deposit amount 726 and/or the upcoming deposit date 728 on upcoming deposit page 720.

While FIGS. 6A-6C and 7A-7B show different embodiments for a split deposit tool, it should be understood that any function of split deposit tool 600 may be substituted for any function of split deposit tool 700, and vice versa. Likewise, any function of split deposit tool 700 not included in split deposit tool 600 as described may be included in split deposit tool 600, and vice versa. For example, in some embodiments, split deposit tool 600 may display a remaining daily deposit limit 716 and/or a remaining monthly deposit limit 718. Likewise, split deposit tool 600 may provide for the selection of a deposit storage location 710 and/or the display of upcoming deposits on an upcoming deposits page 720.

Further, while FIGS. 6A-6C and 7A-7B show the selection of deposit splits for a single destination account 722, in some embodiments, split deposit tools 600/700 may allow a customer to select a destination account for each deposit of the deposit splits.

FIG. 8 depicts a split deposit system 800, according to some embodiments. Operations described may be implemented by processing logic that may include hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 8, as will be understood by a person of ordinary skill in the art.

As shown in FIG. 8, split deposit system 800 may include a check deposit application programming interface (API) 802. Check deposit API 802 may be an intermediary software interface between mobile banking app 304, installed on client device 302, and funds availability model(s) 412 (operating on client device 302 and/or cloud banking system 316). In some embodiments, check deposit API 802 may also interface with a transaction database (DB) 806. Transaction DB 806 may be any suitable form of database, such as a hierarchical database, a network database, an object-oriented database, a relational database, a cloud database, a centralized database, and/or a NoSQL database. In some embodiments, check deposit API may overlap with API 318 described with respect to FIG. 3. Check deposit API 802 may receive check data gathered in real-time (e.g., an amount extracted from a check image) and transfer the check data to funds availability model(s) 412. In response, check deposit API 802 may receive outputs from funds availability model(s) 412 and communicate the outputs to mobile banking app 304. In some embodiments, the outputs may include or be used to generate funds availability parameters 414 and/or remote deposit status 416, which may be transferred through remote deposit platform 410 shown in FIG. 4.

In some embodiments, mobile banking app 304 may maintain real-time communication with one or more funds availability model(s) 412 via check deposit API 802. For example, mobile banking app 304 may feed an amount of a deposit (e.g., deposit amount 706 first deposit 704a) selected by a customer to one or more funds availability model(s) 412, which may determine allowed dates for deposit and feed the allowed dates back to mobile banking app 304 (or vice versa: receive a selected date and feed allowed amounts back to mobile banking app 304) to be offered to the customer as available selections. In some embodiments, mobile banking app 304 may feed an amount and date of a deposit (e.g., deposit amount 706 and deposit date 708 of first deposit 704a) selected by the customer to one or more funds availability model(s) 412 for vetting of the selected amount and date. Based on the results of the vetting, a remote deposit status 416 may be fed back to mobile banking app 304 (selection confirmed or rejected).

To perform the functions described herein, funds availability model(s) 412 may include one or any combination of the following models. Further, any one or more of the below models may be combined with another one or more model to form a single model:
1. A limit assessment model: Used to determine whether an amount exceeds an existing remote deposit limit. The limit assessment model may receive as inputs a check amount (e.g., check amount 614/714), the current date, user deposit history at least within a current limit timeframe (e.g., day, month), and limit policies for the customer. In some embodiments, the limit policies may include one or more of a customer-specific limit, an account specific limit (e.g., based on account time), or a global limit (applies to all customers). The limit assessment model may provide as an output whether the check amount exceeds a remaining remote deposit limit. In some embodiments, the limit assessment model may further predetermine-based on the check amount, user deposit history at least within a current limit timeframe, and limit policies for the customer-available dates for various fractional portions of the check amount. In such embodiments, mobile banking app 304 may use the outputs of the limit assessment model to initially display to the customer available amounts/dates for selection in split deposit tool 600/700. Likewise, in some embodiments, the limit assessment model may receive a fractional amount selected by the customer and determine whether a remote deposit limit is exceeded for various dates, and supply available deposit dates, given the fractional amount, for use by mobile banking app 304. In some embodiments, the limit assessment model may receive a deposit date selected by the customer and determine whether a remote deposit limit is exceeded for various amounts, and supply available deposit amounts, given the selected date, for use by mobile banking app 304. Finally, in some embodiments, the limit assessment model may receive a deposit amount and date selected by the customer and determine whether the deposit amount and date causes a remote deposit limit to be exceeded.

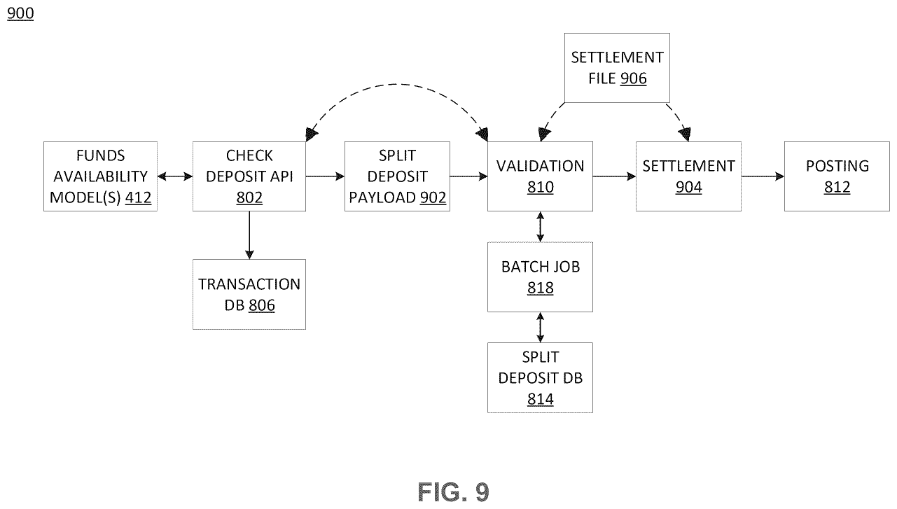

In some embodiments, the limit assessment model may operate on client device 302 (e.g., as part of mobile banking app 304). In some embodiments, the limit assessment model may operate on a backend server of cloud banking system 316.
2. One or more ML funds availability schedule models: Used to determine when an amount would be available to the customer (i.e., available deposit dates that may be displayed in mobile banking app 304 as selectable options). Example ML funds availability schedule models that may be used are described in U.S. application Ser. No. 18/509,748, filed Nov. 15, 2023 and titled “DEPOSIT AVAILABILITY SCHEDULE,” the disclosure of which is incorporated by reference herein in its entirety. (U.S. application Ser. No. 18/509,748 refers to the ML funds availability schedule model(s) incorporated herein as “funds availability model 312” or “funds availability models 520 (1-N)” implemented using “ML engine 518”.) The ML funds availability schedule model(s) may receive as inputs a check amount (e.g., check amount 614/714 gathered using real-time OCR and/or input by the customer), check data gathered using real-time OCR (enumerated in U.S. application Ser. No. 18/509,748), which in this case includes active OCR, customer history, which may include payer and payee customer data, bank funding policies, legal requirements (e.g., state or federally mandated limits and reporting requirements), etc. The ML funds availability schedule model(s) may provide as an output a date that an amount (either the full check amount or a fractional amount) will be available to the customer (deposit completed and funds disbursed). In some embodiments, the ML funds availability schedule model(s) may predetermine available dates for the check amount and/or one or more fractional amounts. In such embodiments, mobile banking app 304 may use the outputs of the ML funds availability schedule model(s) to display to the customer available dates, given an amount, for selection in split deposit tool 600/700. Likewise, in some embodiments, the ML funds availability schedule model(s) may receive a fractional amount selected by the customer and determine when the fractional amount would be available to the customer, and supply available deposit dates, given the fractional amount, for mobile banking app 304 to display to the customer.
3. A ML risk-assessment model: Used to determine a fraud risk associated with a customer. The ML risk-assessment model may receive as inputs customer historical data and may provide as an output a risk score for the customer. The risk score may be used to determine whether deposits should be delayed (e.g., until image validation and/or a settlement process is completed) due to elevated risk or may be released to the customer early. Accordingly, in some embodiments, the dates mobile banking app 304 provides to the user as available deposit dates may be based on the risk score. In some embodiments, mobile banking app 304 may use the risk score to modulate available dates calculated using any one or more of the other funds availability model(s) 412 described herein.
4. A ML limit override model: Used to determine whether a customer is eligible for a limit override. An example ML limit override model that may be used is described in U.S. application Ser. No. 18/116,552, filed Mar. 2, 2023 and titled “EXCEPTION HANDLING USING INSTANT OPTICAL CHARACTER RECOGNITION,” the disclosure of which is incorporated herein by reference in its entirety. (U.S. application Ser. No. 18/116,552 refers to the ML limit override model incorporated herein as “Limits Model 128” or “Limits Model 312”.) The ML limit override model may receive as inputs check data gathered using real-time OCR (which in this case may include active OCR), the customer's account history, the customer's transaction history, and other user information, as described in U.S. application Ser. No. 18/116,552. The ML limit override model may provide as an output a confidence score indicating the confidence that an upload (deposit) will be successful and presents minimal risk. If the confidence score exceeds a predetermined threshold (which may be user-specific or global), remote deposit system 300 may override current remote deposit limits. Accordingly, in some embodiments, if the limit assessment model determines an amount exceeds a remaining remote deposit limit, the ML limit override model may determine whether the customer is eligible for a limit override for the amount (e.g., check amount 614/714 or a fractional amount). If so, in some cases, the output of the ML limit override model may prevent split deposit tool 600/700 from being activated in mobile banking app 304. In such cases, a deposit may proceed without split deposit being required. In other cases, the ML limit override model may be run on a selected fractional amount that still exceeds a remote deposit limit, and it may be determined that the remote deposit limit may be overridden for the fractional amount such that no further split is required.
5. A settlement estimate model: Used to determine a typical amount of time until a settlement process with the payer's bank is completed. The settlement estimate model may receive as inputs the payer's bank (identified using the routing number included in MICR line 220) and/or check amount 614/714. The settlement estimate model may provide as an output an estimated date for completion of settlement of funds that include the check amount 614/714. In some embodiments, the estimated date for settlement completion (or a date thereafter) may be provided to the customer as an available deposit date, even if the estimated date for settlement completion (or the date thereafter) would cause a deposit to exceed a remaining remote deposit limit. Such embodiments are described in more detail with respect to FIG. 9. Accordingly, in some embodiments, the dates mobile banking app 304 provides to the user as available deposit dates may be based on the estimated settlement completion date output by the settlement estimate model.
6. One or more pattern divergence models: Used to determine whether a submitted check image represents a divergence from past remote deposit patterns, such that a risk of fraud may be elevated. Example pattern divergence models that may be used are described in U.S. application Ser. No. 18/607,884, filed Mar. 18, 2024 and titled “DOCUMENT REMEMBRANCE AND COUNTERFEIT DETECTION,” and U.S. application Ser. No. 18/621,948, filed Mar. 29, 2024 and titled “REAL-TIME DOCUMENT IMAGE EVALUATION,” the disclosures of which are incorporated herein by reference in their entireties. The outputs of the pattern divergence models may be used to determine whether deposits should be delayed (e.g., until image validation and/or a settlement process is completed) due to an elevated risk or may be released to the customer early. Accordingly, in some embodiments, the dates mobile banking app 304 provides to the user as available deposit dates may be based on the outputs. In some embodiments, mobile banking app 304 may use the outputs to modulate available dates calculated using any one or more of the other funds availability model(s) 412 described herein.
7. An ML split deposit model: Used to determine a risk score associated with various split deposit configurations. The ML split deposit model may receive as inputs at least data on split deposits (e.g., check amount, split amounts, deposit dates, current date, etc.). In some embodiments, the ML split model may also receive as an input data indicating remaining remote deposit limit(s). The ML split deposit model may provide as an output a risk score associated with a given split deposit configuration selected by the customer. In some embodiments, the risk score may indicate a likelihood a split configuration will not be successfully completed (e.g., due to fraud detection). In some embodiments, mobile banking app 304 may use the risk score to modulate available dates calculated using any one or more of the other funds availability model(s) 412 described herein (e.g., to avoid more risky configurations being provided to the customer as available options), and/or to generate remote deposit status 416. In some embodiments, the ML split deposit model may be integrated with the ML funds availability schedule model and/or the ML risk assessment model.

In some embodiments, the ML split deposit model may have been trained on data retrieved from split deposit DB 814 and/or transaction DB 806 (e.g., check amount, split amounts, deposit dates, image submission dates, etc.) and categorization data that indicated whether a particular split deposit configuration was successfully completed (funds settled and disbursed). In some embodiments, the ML split model may also have been trained on data indicating remaining remote deposit limit(s) at the time of image submission.

In all cases described above, one or more outputs of funds availability model(s) 412 may make up or be used to generate funds availability parameters 414 and/or remote deposit status 416.

Once a user has selected deposit amount(s) 706, deposit date(s) 708, and/or deposit storage location(s) 710 (collectively, “split deposit data”) using split deposit tool 600/700 of mobile banking app 304, check deposit API 802 may receive and transmit the split deposit data to transaction DB 806 for storage. Along with the split deposit data, check deposit API 802 may transmit one or more of the total check amount 714, check images, the date of submission of the check images, account number(s) of the destination account(s) (e.g., account 722), and a customer ID to transaction DB 806 for storage. In some embodiments, transaction DB 806 may be stored on cloud banking system 316. Transaction DB 806 may be separate from or may form a part of file DB 320 described with respect to FIG. 3.

As shown in FIG. 8, a categorization module 808 may link to transaction DB 806. In some embodiments, categorization module 808 may categorize transaction data in transaction DB 806 into standard deposit data 809 and delayed deposit data 813. Standard deposit data 809 may include data related to a deposit that is being processed according to standard remote deposit procedures (i.e., the procedures include no delay to allow for a remote deposit limit to reset). In some embodiments, for example, standard deposit data 809 may include deposit amount 706 and deposit date 708 of first deposit 704a, which may be processed according to standard remote deposit procedures since it does not exceed a remote deposit limit. In some embodiments, standard deposit data 809 may also include one or more of a destination account number, the customer ID, a check/submission identifier (e.g., an alphanumeric or numeric identifier unique to the deposit attempt), and a transaction code generated by categorization module 808. Delayed deposit data 813 may include data related to a deposit that is being processed according to delayed remote deposit procedures (i.e., the procedures include a delay to allow for a remote deposit limit to reset before deposit is completed). In some embodiments, for example, delayed deposit data 813 may include deposit amount(s) 706 and deposit date(s) 708 of second deposit 704b and/or third deposit 704c, which may be processed according to delayed remote deposit procedures. Like standard deposit data 809, in some embodiments, delayed deposit data may include one or more of at least one destination account number, the customer ID, the check/submission identifier, and at least one transaction code generated by categorization module 808, each of second and third deposits 704b-c being associated with a transaction code of the at least one transaction code.

In some embodiments, standard deposit data 809 may be transmitted, along with the check images, for validation 810. Validation 810 may include any known image and/or account validation processes, and may be performed at a backend server using software developed by the bank implementing cloud banking system 316 and/or using third party software. Validation 810 may include further OCR processing, image quality checks, payee and/or payer account verification, etc. In some embodiments, validation 810 may be performed using validation module 326, described with respect to FIG. 3. If the standard deposit data 809 and check images pass validation 810, the deposit associated with standard deposit data 809 may proceed to posting 812. At posting 812, the deposit is posted to the customer's account and funds are released to the customer.

As shown in FIG. 8, categorization module 808 may forward delayed deposit data 813 to a split deposit database (DB) 814. The delayed deposit data 813 may be stored in split deposit DB 814. Split deposit DB 814 may be any suitable form of database, such as a hierarchical database, a network database, an object-oriented database, a relational database, a cloud database, a centralized database, and/or a NoSQL database. In some embodiments, split deposit DB 814 may be stored on cloud banking system 316. Split deposit DB 814 may be separate from or may form a part of file DB 320 described with respect to FIG. 3. In some embodiments, split deposit DB 814 may interface and/or be a part of pending deposit 330 and/or deposit retention module 336 described with respect to FIG. 3. Pending deposit 330 and/or deposit retention module 336 may interface with mobile banking app 304, for example, via mobile app server 332 and/or API 318 to provide upcoming deposit data for display on upcoming deposit page 720, described with respect to FIG. 7.

Validation 810 may identify rejections, for example, deposit attempts that cannot be completed for any reason, including image quality deficiencies, fraud alerts, etc.). In some embodiments, a rejections module 816 may receive data associated with a rejected check image (e.g., the customer ID, check/submission identifier, the destination account number(s), and/or the transaction code of standard deposit data 809) and may use the data to update split deposit DB 814. For example, rejections module 816 may identify associated upcoming deposits (e.g., scheduled deposits related to the check/submission identifier) in split deposit DB 814. Then, rejections module 816 may mark any associated upcoming deposits as cancelled or may remove the associated upcoming deposits from split deposit DB 814. In some embodiments, rejections module 816 may also mark upcoming deposits that are associated with validated check images as validated and ready for posting, based on data from validation 810.

As shown in FIG. 8, a batch job 818 may be run at predetermined time intervals to identify upcoming deposits stored in split deposit DB 814 that are ready for posting. In some embodiments, the predetermined time intervals may be regular (e.g., hourly or daily). In some embodiments, the batch job 818 may search split deposit DB 814 for deposit date(s) 708 that match the date the batch job 818 is being run. Upon identifying matching deposit date(s), batch job 818 may assemble a posting file 820 listing the deposits that are ready for posting. The posting file 820 may be transmitted and posting 812 of the deposits to destination accounts may be completed.

For a delayed deposit, in some embodiments, posting 812 may include automatically transferring the funds to the destination account from a deposit retention vehicle 712. For a delayed deposit, in some embodiments, posting 812 may include informing the customer that the funds are available for transfer to the destination account from the deposit retention vehicle 712.

FIG. 9 depicts a split deposit system 900, according to some embodiments. Operations described may be implemented by processing logic that may include hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 9, as will be understood by a person of ordinary skill in the art.

In split deposit system 900, rather than categorizing transaction data at a categorization module 808, check deposit API 802 may provide a split deposit payload 902 for validation 810. Split deposit payload 902 may include data of both standard deposit data 809 and delayed deposit data 813 as described herein. For example, split deposit payload 902 may include check images, deposit amount(s) 706 and deposit date(s) 708 for all deposit splits, destination account number(s), a check/submission identifier, and/or transaction code(s) for all deposit splits. In some embodiments of FIG. 9, validation 810 may be performed before or in concert with storage of deposit split data in split deposit DB 814. For example, in some embodiments, each deposit of the deposit splits may be validated and stored in split deposit DB 814 by validation 810 systems. Upon validation, batch job 818 may identify upcoming deposits that are ready for posting and may forward information on the identified deposits for posting 812, before or after a settlement 904 process is completed.

Additionally or alternatively to the methods described so far with respect to FIGS. 8 and 9, split deposit systems 800 and/or 900 may perform a full settlement of deposit funds prior to disbursement, allowing deposit funds to be posted safely in contravention of a remote deposit limit. Such a full settlement embodiment is illustrated in FIG. 9 using dotted lines, but may apply equally to split deposit system 800 of FIG. 8.

Check deposit API 802 may receive data from funds availability model(s) 412 indicating that a remote deposit limit is exceeded by a check being deposited. Check deposit API 802 may transmit an indication that a remote deposit limit is exceed to validation 810 systems (e.g., components of validation module 326). In some embodiments, in response, validation 810 systems may mark a settlement file 906 associated with the check that exceeds a remote deposit limit and may track the outcome of settlement file 906. In some embodiments, settlement file 906 may include an identifier for the check and its amount, the payer's account information, the payer bank's routing number, and/or other identifying information. In some embodiments, validation 810 systems may determine that settlement 904 is complete for transaction(s) listed on settlement file 906 and funds related to the check were successfully received by the payee customer's bank as part of settlement 904 (or the proper net amount of funds were paid by the payee customer's bank to the payer's bank). In some embodiments, settlement 904 may be real-time settlement, for example, real-time gross settlement (i.e., transaction-by-transaction settlement). In some embodiments, settlement 904 may be deferred settlement, for example, deferred net settlement. In some embodiments, settlement file 906 may be a file tracking settlement data related to one or more checks submitted for remote deposit within a current settlement timeframe (e.g., a time period between settlements, as arranged between two financial institutions).

In some embodiments, once validation 810 systems have determined that settlement is complete and check funds tracked in settlement file 906 have been correctly reconciled as part of the settlement, validation 810 systems may forward the check for posting 812 even though the check exceeds a remaining remote deposit limit. Since settlement 904 has completed, it has been proven that the check is not fraudulent and the transaction of funds has been successfully completed. Accordingly, in such embodiments, the need for a remote deposit limit may be removed.

In some embodiments, split deposit system 900 may release deposit funds up to a remaining remote deposit limit, while waiting for settlement 904 to complete before releasing remaining funds associated with a check. For example, if a customer attempts to deposit a $50,000 check, and a remaining monthly remote deposit limit is $15,000, split deposit system 900 may release $15,000 for deposit while waiting for settlement 904 to be completed before releasing the remaining $35,000. In such embodiments, split deposit system 900 may release the remaining $35,000 for deposit even before the month's end, in technical violation of the remaining monthly remote deposit limit, since the funds have cleared and there are no outstanding issues related to fraud or insufficient funds in a payer's account.

In some embodiments, split deposit system 900 may hold an entirety of a check amount that exceeds a remaining remote deposit limit until settlement 904 is completed. Split deposit system 900 may then release the entirety of the check amount for deposit upon successful completion of settlement 904, even if depositing the check amount causes a remaining remote deposit limit to be violated. In embodiments in which split deposit system 900 holds an entirety of a check amount until settlement 904 is completed, split deposit payload 902 may only include data for a single deposit (the entirety of the check amount), and split deposit DB 814/batch job 818 may be unnecessary. Further, in such embodiments, the display of split deposit tool 600/700 may be unnecessary. In such embodiments, a customer may simply be provided with a remote deposit status 416 that includes an estimated funds availability date, which may be calculated using the settlement estimate model described with respect to FIG. 8.

Whether funds up to a remaining remote deposit limit are released and remaining funds associated with a check are released after successful completion of settlement 904 (a first case), or an entirety of the check amount is held until successful completion of settlement 904 (a second case), the deposit date(s) may be determined by split deposit system 900 rather than a customer (e.g., based on when settlement 904 is successfully completed). Likewise, the deposit amount(s) may be determined by split deposit system 900 rather than the customer. Accordingly, in both cases the display of split deposit tool 600/700 may be unnecessary. However, in the first case, it may be desirable to trigger the display of split deposit tool 600/700 such that a customer may determine one or more deposit amounts and/or one or more deposit dates for the first portion (up to the remaining remote deposit limit) and the second portion (remaining funds associated with the check). And, as noted herein, split deposit tool 600/700 may be displayed in all instances to allow a customer greater control over remote deposit funds availability.

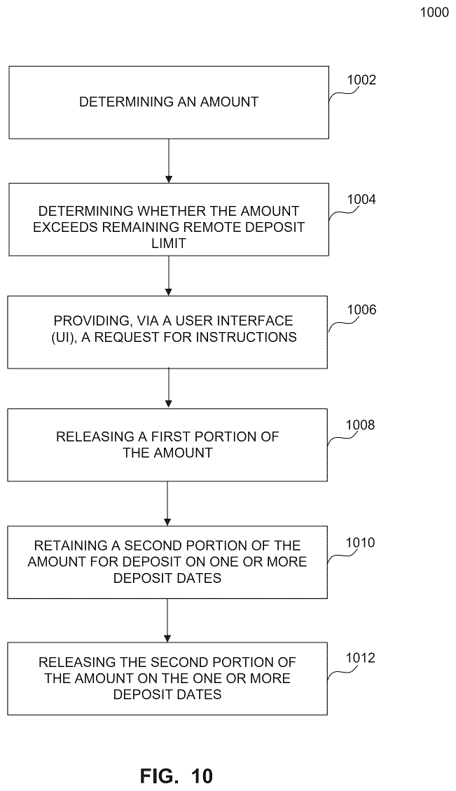

FIG. 10 is a flow chart depicting a method 1000 that may be carried out in line with the discussion above. One or more of the operations in the method depicted by FIG. 10 could be carried out by one or more entities, including, without limitation, client device 302, cloud banking system 316, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some embodiments, the systems described implement a split deposit and deposit scheduler for managing attempted deposits that exceed a remaining remote deposit limit.

Unless stated otherwise, the steps of method 1000 need not be performed in the order set forth herein. Additionally, unless specified otherwise, the steps of method 1000 need not be performed sequentially. The steps may be performed in a different order or simultaneously. Further, method 1000 may not include all the steps illustrated. For example, in some embodiments, method 1000 may not include steps 1008, 1010, and 1012. Instead, method 1000 may include releasing all of the amount determined in step 1002, either before settlement (e.g., if the amount does not exceed a remaining deposit limit or a limit override is performed) or after a settlement. As another example, method 1000 may not include step 1006, for example, if the selection of deposit dates is automatically performed.

Step 1002 may include determining an amount (e.g., amount 212/614/714). In some embodiments, the determining an amount of step 1002 may include determining an amount from an image of a financial instrument (e.g., check 106) submitted by a user for remote deposit. In some embodiments, the determining the amount from the image may include performing real time optical character recognition (OCR) on the image. In some embodiments, the real time OCR may include active OCR performed at a mobile device (e.g., mobile computing device 102/client device 302). In some embodiments, the determining an amount of step 1002 may include receiving an amount entered manually by the user as part of the remote deposit image submission process.

Step 1004 may include determining whether the amount exceeds a remaining remote deposit limit. In some embodiments, the determining whether the amount exceeds the remaining remote deposit limit of step 1004 may be performed by a limit assessment model (e.g., one of funds availability model(s) 412).

Step 1006 may include providing to the user, via a user interface (UI) (e.g., UI 306) of a mobile device (e.g., mobile computing device 102/client device 302), a request for instructions (e.g., user instructions request 702 as provided in split deposit tool 700). In some embodiments, instructions may be requested regarding at least one of a first portion (e.g., deposit amount 706 of first deposit 704a) of the amount, a second portion (e.g., deposit amount 706 of second deposit 704b and/or third deposit 704c) of the amount, one or more deposit dates (e.g., deposit date 708 of second deposit 704b and/or third deposit 704c), or one or more deposit retention vehicles (e.g., one or more deposit retention vehicles 712). In some embodiments, the request for instructions may be provided to the user in response to the amount exceeding the remaining remote deposit limit. In some embodiments, the request for instructions may be provided to the user in real time (e.g., within a current customer transaction period before the user submits a deposit request or immediately after in response to the user submitting the deposit request). In some embodiments, the first portion of the amount may be selectable by the user via the UI. In some embodiments, the second portion of the amount may be selectable by the user via the UI. In some embodiments, the second portion of the amount may be split by the user into one or more sub-portions (e.g., deposit amount 706 of second deposit 704b and/or third deposit 704c) via the UI. In some embodiments, an amount (e.g., deposit amount 706) of each of the one or more sub-portions may be selectable by the user via the UI. In some embodiments, the one or more deposit dates may be selectable by the user via the UI. In some embodiments, the one or more deposit retention vehicles may be selectable by the user via the UI.

Step 1008 may include releasing the first portion of the amount into a user account (e.g., account 722), the first portion being less than or equal to the remaining deposit limit. In some embodiments, the releasing the first portion of step 1008 may be in response to the amount exceeding the remaining remote deposit limit.

Step 1010 may include retaining the second portion of the amount for deposit on the one or more deposit dates. In some embodiments, the retaining the second portion of step 1010 may include retaining the second portion of the amount in the one or more deposit retention vehicles for deposit into the user account. In some embodiments, the one or more deposit dates may be different from a date the financial instrument is submitted by the user. In some embodiments, the one or more deposit dates may be determined by a remote deposit system (e.g., split deposit system 900). In some embodiments, the one or more deposit dates may be after the completion of a settlement process (e.g., settlement 904) associated with the financial instrument.

Step 1012 may include releasing the second portion of the amount on the one or more deposit dates. In some embodiments, the releasing the second portion of step 1012 may include releasing the second portion of the amount into the user account. In some embodiments, the releasing the second portion of step 1012 may include exceeding the remaining remote deposit limit (e.g., as described with respect to FIG. 9). In some embodiments, the releasing the second portion of step 1012 may include storing, in a database (e.g., split deposit DB 814), a unique identifier associated with the user (e.g., a customer ID), at least one of data on the second portion of the amount or data on one or more sub-portions of the second portion, an account number of the user account, and the one or more deposit dates. In some embodiments, the storing may be in response to a user input on the UI (e.g., UI 306 providing split deposit tool 600/700) of the mobile device (e.g., mobile computing device 102/client device 302). In some embodiments, the releasing the second portion of step 1012 may include determining whether a current date (e.g., a date batch job 818 is being run) matches the one or more deposit dates. In some embodiments, the determining whether the current date matches the one or more deposit dates may include scanning the database to detect when the current date matches the one or more deposit dates. In some embodiments, the scanning may be performed at regular time intervals. In some embodiments, the releasing the second portion of step 1012 may include releasing, into the user account, the second portion of the amount or a sub-portion of the one or more sub-portions in response to the current date matching the one or more deposit dates.

In some embodiments, the one or more deposit retention vehicles may include a certificate of deposit (CD).

In some embodiments, method 1000 may include displaying, via the UI (e.g., UI 306) of the mobile device (e.g., mobile computing device 102/client device 302), a graphical representation (e.g., via upcoming deposits page 720) of the one or more deposit retention vehicles. In some embodiments, the graphical representation may include at least one of a pending deposit amount (e.g., an upcoming deposit amount 726) or a pending deposit interest accrual amount (e.g., an interest 732).

While the above disclosure describes split deposit for checks, this disclosure contemplates using images of any financial instrument document that may be deposited, for example, money orders. Additionally, the embodiments disclosed herein may be implemented with any type of document that is used to obtain access to services, goods, or funds (e.g., a purchase order, an identification document such as a passport, license, social security card, birth certificate, student card, etc.), and/or with no document (e.g., an order for services, goods, or funds is electronically submitted without an image of a document or an amount of services, goods, or funds is not specified on a document provided with a request for services, goods, or funds).

The solutions described above provide technical solutions to shortcomings of current remote deposit image capture processes. The various embodiments solve at least the technical problems associated with determining a check exceeds a remaining remote deposit limit in real-time and providing a customer the ability to split and schedule deposits to circumnavigate remote deposit limits. The various embodiments encompassed by the technology disclosed herein are able to provide accurate OCR results, before the customer completes the transaction, to enable determination of whether an attempted deposit exceeds a remote deposit limit. Further, the various embodiments described herein aid the customer with easily and properly splitting and scheduling the attempted deposit to ensure that remote deposit limits are respected, while reducing customer frustration and providing the customer control over funds availability.

Similarly, various embodiments solve technical problems associated with overriding or disregarding remote deposit limits while maintaining adequate fraud protection measures. The various embodiments encompassed by the technology disclosed herein are able to 1) conduct an assessment of whether a customer is eligible for a limit override and/or 2) ensure a check successfully passes through a settlement process to ascertain whether it is safe to disburse funds to the customer despite the deposit exceeding a remote deposit limit. The various embodiments described herein may reduce or eliminate customer frustration with remote deposit limits, while retaining proper vetting of transactions.

In the various embodiments described herein, the need to retain a physical copy of a check until a remote deposit limit no longer applies may be reduced or eliminated, reducing potential fraud risk (theft and alteration of the check) and burden on the customer.

### Example Computer System

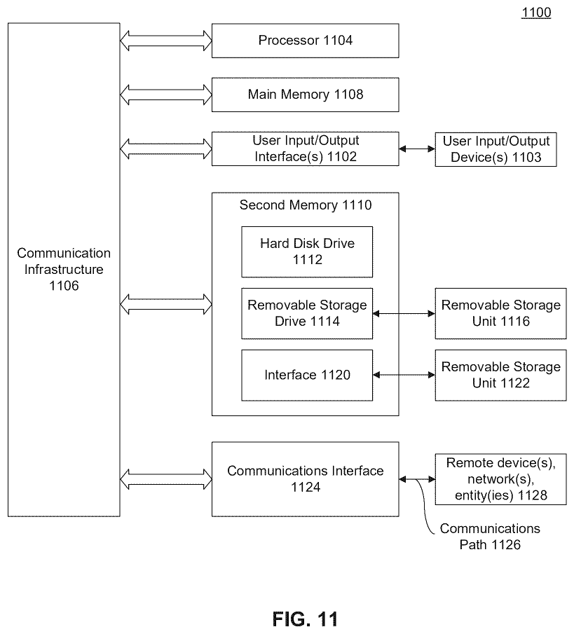

FIG. 11 depicts an example computer system useful for implementing various embodiments.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof. For example, the example computer system may be implemented as part of mobile computing device 102, client device 302, cloud banking system 316, etc. Cloud implementations may include one or more of the example computer systems operating locally or distributed across one or more server sites.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1116. Removable storage unit 1116 may include a computer usable or readable storage device having stored thereon computer software (control logic) and/or data. Removable storage unit 1116 may be a floppy disk, magnetic tape, compact disk, DVD, optical storage disk, and/any other computer data storage device. Removable storage drive 1114 may read from and/or write to removable storage unit 1116.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1116 and 1122, as well as tangible articles of manufacture embodying any combination of the foregoing. Such control logic, when executed by one or more data processing devices (such as computer system 1100), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A computer-implemented method for a remote deposit environment, comprising:
determining an amount from an image of a financial instrument submitted by a user for remote deposit, the determining the amount comprising performing real time optical character recognition (OCR) on the image;
determining whether the amount exceeds a remaining remote deposit limit;
in response to the amount exceeding the remaining remote deposit limit, providing to the user in real time, via a user interface (UI) of a mobile device, a request for instructions regarding at least one of a first portion of the amount, a second portion of the amount, one or more deposit dates, or one or more deposit retention vehicles;
releasing the first portion of the amount into a user account, the first portion being less than or equal to the remaining deposit limit;
retaining the second portion of the amount in the one or more deposit retention vehicles for deposit into the user account on the one or more deposit dates, the one or more deposit dates being different from a date the financial instrument is submitted by the user;
releasing the second portion of the amount into the user account on the one or more deposit dates.

2. The method of claim 1, wherein the one or more deposit dates are determined by a remote deposit system and are after the completion of a settlement process associated with the financial instrument.

3. The method of claim 2, wherein releasing the second portion of the amount into the user account comprises exceeding the remaining remote deposit limit.

4. The method of claim 1, wherein the first portion of the amount is selectable by the user via the UI.

5. The method of claim 1, wherein the second portion of the amount is selectable by the user via the UI.

6. The method of claim 5, wherein the second portion of the amount may be split by the user into one or more sub-portions via the UI, and wherein an amount of each of the one or more sub-portions is selectable by the user via the UI.

7. The method of claim 1, wherein the one or more deposit dates are selectable by the user via the UI.

8. The method of claim 1, wherein the one or more deposit retention vehicles are selectable by the user via the UI.

9. The method of claim 8, wherein the one or more deposit retention vehicles comprise a certificate of deposit (CD).

10. The method of claim 1, further comprising displaying, via the UI of the mobile device, a graphical representation of at least one of the one or more deposit retention vehicles.

11. The method of claim 10, wherein the graphical representation comprises at least one of a pending deposit amount or a pending deposit interest accrual amount.

12. The method of claim 1, wherein the releasing the second portion of the amount into the user account comprises:
storing, in a database:
a unique identifier associated with the user,
at least one of data on the second portion of the amount or data on one or more sub-portions of the second portion,
an account number of the user account, and
the one or more deposit dates;
determining whether a current date matches the one or more deposit dates; and
in response to the current date matching the one or more deposit dates, releasing, into the user account, the second portion of the amount or a sub-portion of the one or more sub-portions.

13. The method of claim 12, wherein the storing is in response to a user input on the UI of the mobile device.

14. The method of claim 12, wherein the determining whether the current date matches the one or more deposit dates comprises scanning the database to detect when the current date matches the one or more deposit dates, the scanning being performed at regular time intervals.

15. The method of claim 1, wherein the real time OCR comprises active OCR performed at the mobile device.

16. A system, comprising:
a memory; and
at least one processor coupled to the memory and configured to:
determine an amount from an image of a financial instrument submitted by a user for remote deposit;
determine whether the amount exceeds a remaining remote deposit limit;
in response to the amount exceeding the remaining remote deposit limit, release a first portion of the amount into a user account, the first portion being less than or equal to the remaining deposit limit;
retain a second portion of the amount in one or more deposit retention vehicles for deposit into the user account on one or more deposit dates, the one or more deposit dates being different from a date the financial instrument is submitted by the user;
release the second portion of the amount into the user account on the one or more deposit dates.

17. The system of claim 16, wherein to determine the amount from the image, the at least one professor is further configured to perform real time optical character recognition (OCR) on the image.

18. The system of claim 17, wherein the at least one processor is further configured to provide to the user in real time, via a user interface (UI) of a mobile device, a request for instructions regarding at least one of the first portion, the second portion, the one or more deposit dates, or the one or more deposit retention vehicles, in response to the amount exceeding the remaining remote deposit limit.

19. The system of claim 17, wherein the real time OCR comprises active OCR performed at a mobile device.

20. A non-transitory computer-readable device having instructions stored thereon that, when executed by at least one computing device, causes the at least one computing device to perform operations comprising:
determining an amount from an image of a financial instrument submitted by a user for remote deposit;
determining whether the amount exceeds a remaining remote deposit limit;
in response to the amount exceeding the remaining remote deposit limit, releasing a first portion of the amount into a user account, the first portion being less than or equal to the remaining deposit limit;
retaining a second portion of the amount in one or more deposit retention vehicles for deposit into the user account on one or more deposit dates, the one or more deposit dates being different from a date the financial instrument is submitted by the user;
releasing the second portion of the amount into the user account on the one or more deposit dates.
